(19) United States
(12) Patent Application Publication
(10) Pub. No.: US 2013/0028312 A1
(43) Pub. Date: Jan. 31, 2013

(54) JOINT DECISION FEEDBACK EQUALIZER AND TRELLIS DECODER

(71) Applicant: TIEN-JU TSAI, Tainan City (TW)

(72) Inventor: TIEN-JU TSAI, Tainan City (TW)

(73) Assignee: HIMAX MEDIA SOLUTIONS, INC., Tainan City (TW)

(21) Appl. No.: 13/191,268

(22) Filed: Jul. 26, 2011

(51) Int. Cl. H04L 27/01

(52) U.S. Cl. 375/233

(57) ABSTRACT

The present invention is directed to joint decision feedback equalizer (DFE) and Trellis decoder adaptable to an Ethernet transceiver. A Trellis coded modulation (TCM) decoder includes a one-dimensional branch metric unit (1D-BMU) configured to calculate 1D branch metrics; a four-dimensional branch metric unit (4D-BMU) configured to combine the 1D branch metrics to generate 4D branch metrics; an add-compare-select unit (ACSU) configured to perform add, compare and select (ACS) operations on the 4D branch metrics for each state to obtain path metrics; and a survivor memory unit (SMU) configured to store and keep track of symbols. A decision feedback unit (DFU) is coupled to receive the symbols from the SMU in order to estimate inter-symbol interference (ISI) quantity, which is then fed back to the 1D-BMU.

### CROSS-REFERENCE TO RELATED APPLICATIONS

The present invention is related to the following co-pending U.S. patent applications filed on Jul. 26, 2011, by the same inventor of the present application and assigned to the same assignee of the present application, entitled ADAPTIVE ETHERNET TRANSCEIVER WITH JOINT DECISION FEEDBACK EQUALIZER AND TRELLIS DECODER (Att. Docket HI8574P) and RECOVERABLE ETHERNET RECEIVER (Att. Docket HI8571P), the disclosures both of which are incorporated herein by reference.

### BACKGROUND OF THE INVENTION

1. Field of the Invention

The present invention generally relates to an Ethernet transceiver, and more particularly to a joint decision feedback equalizer and Trellis decoder adaptable to an Ethernet transceiver.

2. Description of Related Art

Ethernet standards 10BASE-T, 100BASE-TX, 1000BASE-T and higher-speed Ethernet use unshielded twisted pair (UTP) as a transmission medium. As link speed becomes higher, it becomes more difficult to design the physical layer (PHY), when considering constraints such as multipath fading, pulse/white noise, adjacent/co-channel interferences in wireless channel, or inter-symbol interference (ISI), (near-end or far-end) channel crosstalk, echo or thermal noise in wired channel. In gigabit Ethernet (1000BASE-T), Trellis-coded modulation (TCM) is used as error control coding (ECC), which may, in theory, achieve a coding gain of 5.6 dB.

Viterbi decoder is commonly used to decode TCM code. However, it is noticed that the target 5.6 dB coding gain cannot be satisfactorily achieved by the conventional transceiver, particularly the transceiver having separate Viterbi decoder and ISI post-cursor equalizer that may result in error propagation. In order to improve the coding gain and error propagation, Kamran Azadet discloses a 1-tap lookahead-parallel decision feedback decoder (LA-PDFD) in “A 1-Gb/s Joint Equalizer and Trellis Decoder for 1000BASE-T Gigabit Ethernet,” IEEE Journal of Solid-State Circuits, Vol. 36, No. 3, March 2001; and U.S. Pat. No. 7,363,576 entitled “Method and Apparatus for Pipelined Joint Equalization and Decoding for Gigabit Communications,” the disclosures of which are hereby incorporated by reference. The scheme disclosed by Azadet, however, cannot effectively improve the coding gain with respect to Ethernet having a link segment length greater than the specified 100 m. In order to resolve this problem, Lin et al. discloses a P-tap parallel decision feedback decoder (PDFD) in U.S. Pat. No. 7,188,302 entitled “Parallel Decision-Feedback Decoder and Method for Joint Equalizing and Decoding of Incoming Data Stream,” the disclosure of which is hereby incorporated by reference. In spite of the improvement presented in Lin et al., high cost nevertheless accompanies Lin et al.'s scheme. Moreover, complexity in decision making renders the design more complicated.

For the foregoing reasons, a need has arisen to propose a novel scheme that can effectively improve the coding gain in a simplified and economic manner.

### SUMMARY OF THE INVENTION

In view of the foregoing, it is an object of the embodiment of the present invention to provide a joint decision feedback equalizer and Trellis decoder that is capable of simplifying decision feedback unit and/or increasing reliability of a survivor memory unit for an Ethernet transceiver.

According to one embodiment, a joint decision feedback equalizer (DFE) and Trellis decoder adaptable to an Ethernet transceiver comprises a Trellis coded modulation (TCM) decoder and a decision feedback unit (DFU). Specifically, the TCM decoder includes a one-dimensional branch metric unit (1D-BMU), a four-dimensional branch metric unit (4D-BMU), an add-compare-select unit (ACSU) and a survivor memory unit (SMU). The 1D-BMU calculates 1D branch metrics; the 4D-BMU combines the 1D branch metrics to generate 4D branch metrics; the ACSU performs add, compare and select (ACS) operations on the 4D branch metrics for each state to obtain path metrics; and the SMU stores and keeps track of symbols. The DFU receives the symbols from the SMU in order to estimate inter-symbol interference (ISI) quantity, which is then fed back to the 1D-BMU.

### BRIEF DESCRIPTION OF THE DRAWINGS

FIG. 1 schematically shows a communication system compliant with gigabit Ethernet over four category-5 (CAT-5) unshielded twisted pairs (UTPs);

FIG. 2 shows a block diagram of a gigabit Ethernet transceiver of FIG. 1;

FIG. 3 shows a detailed block diagram of the transmitting section of the PCS block of FIG. 2;

FIG. 4A shows a 1D symbol set for a five-level pulse amplitude modulation (PAM5) constellation;

FIG. 4B shows 4D symbol subset partition;

FIG. 4C shows a convolutional code subset mapping table;

FIG. 5 shows trellis state transition of a convolutional code;

FIG. 6 shows a detailed block diagram of the joint DFE & TCM decoder of FIG. 2 according to one embodiment of the present invention;

FIG. 7 shows a detailed block diagram exemplifying the 4D-BMU for calculating 4D branch metrics (4D-BMs) from state 0;

FIG. 8A shows a detailed block diagram exemplifying the ACSU for updating the path metrics for state 0;

FIG. 8B shows a minimum state logic of the ACSU;

FIG. 9A shows a detailed block diagram of the SMU of FIG. 6 according to one embodiment of the present invention;

FIG. 9B shows a detailed block diagram of the SMU of FIG. 6 according to another embodiment of the present invention; and

FIG. 10 shows a detailed block diagram of the DFU of FIG. 6 according to one embodiment of the present invention.

### DETAILED DESCRIPTION OF THE INVENTION

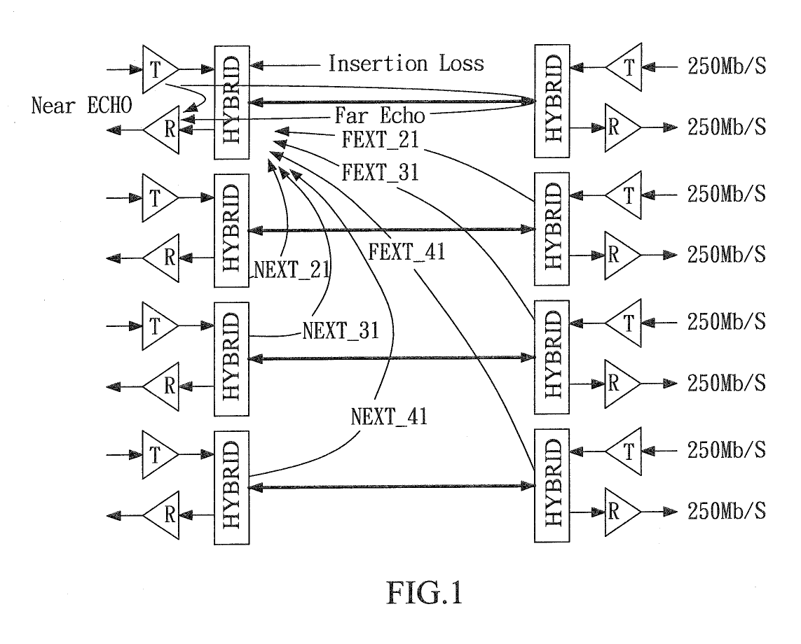

FIG. 1 schematically shows a communication system compliant with gigabit Ethernet over four category-5 (CAT-5) unshielded twisted pairs (UTPs). Near-end or far-end echo occurs as signals are hi-directionally transferred over each wire pair, and near-end crosstalk (NEXT) or far-end crosstalk (FEXT) also occurs as multiple pairs are operated at the same time. Four-dimensional (4D) Trellis coded modulation (TCM) is used in gigabit Ethernet across the four pairs, each of which contributes one-dimension (1D).

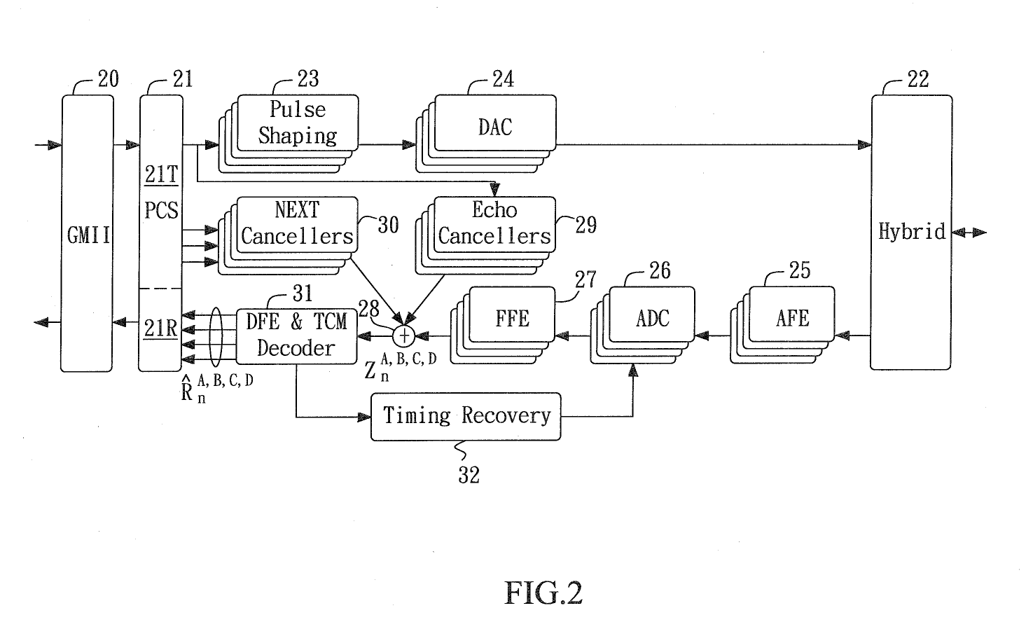

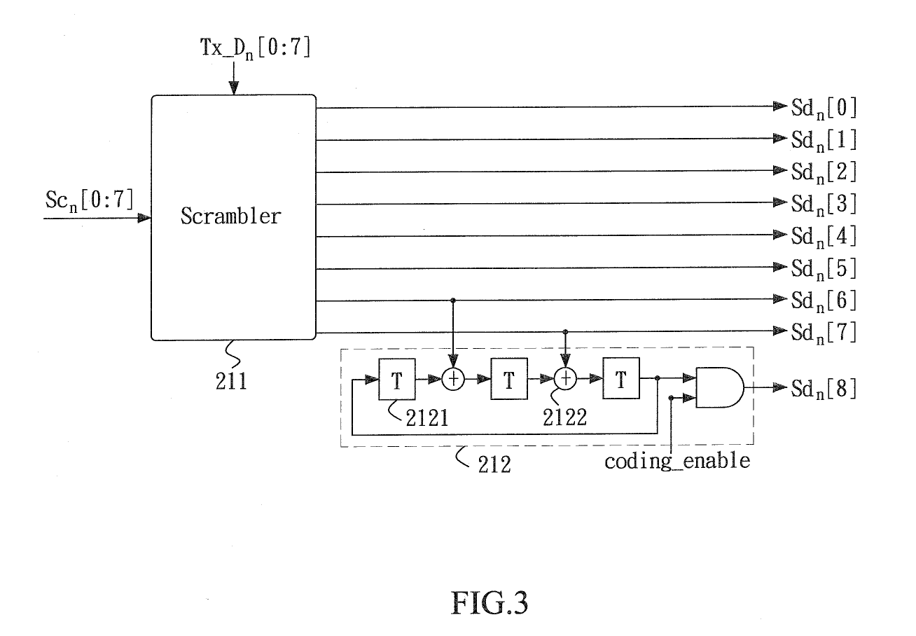

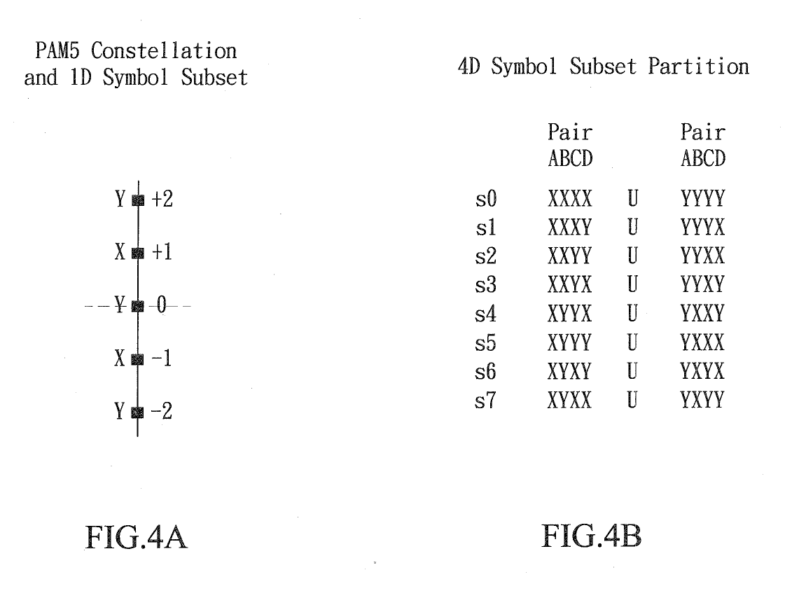

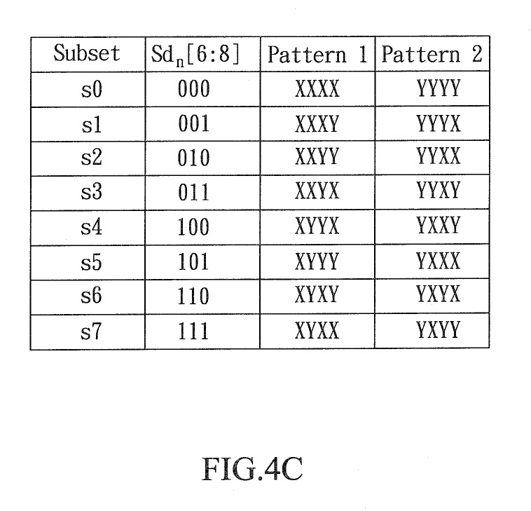

FIG. 2 shows a block diagram of a gigabit Ethernet transceiver of FIG. 1. Only blocks pertinent to the present invention are shown in the figure. On a transmitting path, a Gigabit Medium. Independent Interface (GMII) block 20 receives 8-bit (transmitting) data from Media Access Control (MAC) (not shown) and passes the 8-bit data to the transmitting section 21T of a Physical Coding Sublayer (PCS) block 21. FIG. 3 shows a detailed, block diagram of the transmitting section 21T of the PCS block 21 of FIG. 2. Specifically, the transmitting section 21T of the PCS block 21 performs scrambling on the 8-bit data Tx_Dₙ[0:7] by a scrambler 211, therefore generating 8-bit (scrambled) data Sdₙ[0:7]. The transmitting section 21T of the PCS block 21 also performs TCM coding on the 8-bit data by a convolutional encoder 212 such as a linear feedback shift register that includes three delay elements 2121 and two summing devices 2122 interspersed between the adjacent delay elements 2121. The convolutional encoder 212 receives data Sdₙ[6:7] and accordingly generates (encoded) data Sdₙ[8]. The scrambled data Sdₙ[0:7] and the encoded data Sdₙ[8], 9-bit in total, are then mapped to 4D symbols. Each of the four dimensions corresponds to one of the four wire pairs. In each dimension, possible symbols are selected from a 1D symbol set (−2, −1, 0, +1, +2) as depicted in FIG. 4A, a five-level pulse amplitude modulation (PAM5) constellation. The symbol set is partitioned into two symbol subsets X and Y, for example, with X={−1, +1} and Y={−2, 0, +2}. The 1D symbol subsets are then combined to form 4D symbol subsets (or code subsets) s0 to s7, according to Trellis coding, representing the four wire pairs. As shown in FIG. 4B, each 4D symbol subset includes a union of two complementary 4D symbol subsets, e.g., XXXY and YYYX of s1. FIG. 4C shows a convolutional code subset mapping table that maps data Sdₙ[6:8] (FIG. 3) to code subsets s0-s7.

Referring back to FIG. 2, before the symbols are transmitted to the UTPs via a hybrid block 22, the four 1D symbols are processed by pulse shaping blocks 23 (precisely speaking, partial-response filter may be adopted) respectively to reduce electromagnetic interference (EMI), followed, by being converted to analog signals by digital-to-analog converters (DACs) 24 operating at 125 MHz.

On a receiving path, the hybrid block 22 receives analog signals from four wire pairs. The received 4D signals are then preconditioned respectively by analog front-ends (AFEs) 25 such as programmable gain amplifiers (PGAs), baseline wander compensator (BWC), and programmable low-pass filter (PLPF), followed by being converted to digital signals by analog-to-digital converters (ADCs) operating at 125 MHz. The converted digital signals are processed by feed-forward equalizers (FIFEs) 27 or ISI pre-cursor equalizers. Subsequently, a summing device 28 is used to subtract echo quantity of echo cancellers 29 and near-end crosstalk quantity of NEXT cancellers 30 from the output of the FFE 27. The cancelled signals Zₙ^{A,B,C,D} from the summing device 28 are processed by a joint decision feedback equalizer (DFE, or ISI post-cursor equalizer) and TCM decoder 31, thereby resulting in decoded signals \hat{R}ₙ^{A,B,C,D}, 9-bit data, which are fed to the receiving section 21R of the PCS block 21 and are then further forwarded to the GMII 20. A timing recovery block 32, which is under control of the joint DFE & TCM decoder 31, is also used to control sampling timing of the ADC 26.

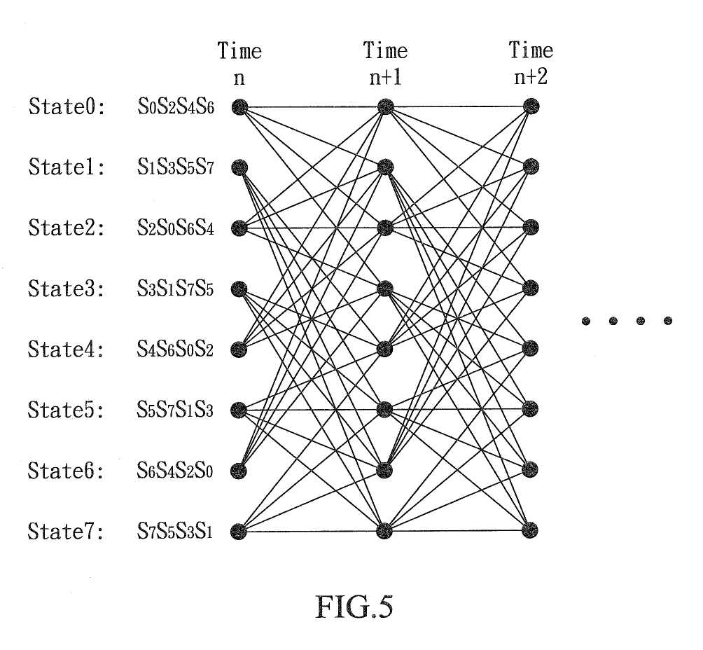

FIG. 5 shows trellis state transition of a convolutional code, i.e., Trellis code. In the trellis diagram, the nodes at the first column represent possible states (state 0 to state 7) that the convolutional encoder 212 (FIG. 3) may assume at time n. Similarly, the nodes at the second and third columns represent possible states at time n+1 and n+2 respectively. From a current state, a subsequent 4D symbol corresponds to a transition (or branch) from the current state to a permissible succeeding state. In other words, each branch may be characterized by a current state, a preceding state and a corresponding 4D symbol. Accordingly, a valid sequence of states (or a valid sequence of 4D symbols) may be represented by a path through the trellis. The trellis diagram may be adapted, at the receiver end, to decode the signals Zₙ^{A,B,C,D} (FIG. 2), by the joint DFE & TCM decoder 31, according to Viterbi algorithm. Given a sequence of received symbols, the most likable path to every node is calculated and the distance between each path and the received sequence is determined in order to determine a path metric.

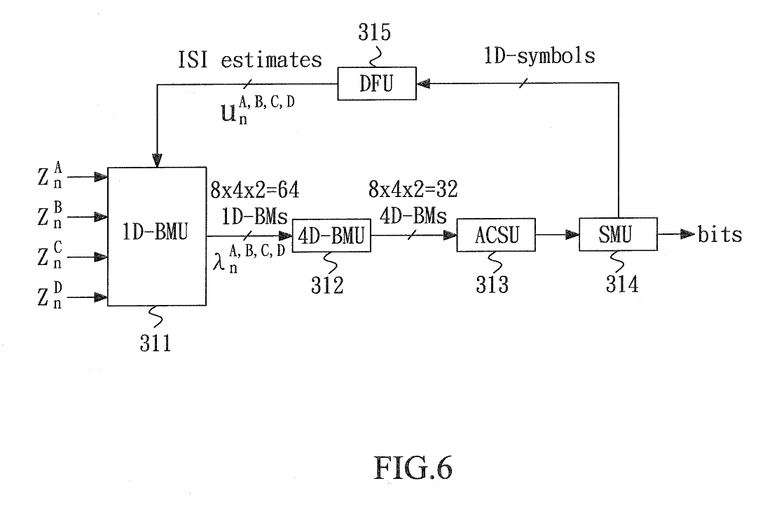

FIG. 6 shows a detailed block diagram of the joint DFE & TCM decoder 31 (FIG. 2), according to one embodiment of the present invention, which includes a 1D branch metric unit (1D-BMU) 311, a 4D branch metric unit (4D-BMU) 312, an add-compare-select unit (ACSU) 313, a survivor memory unit (SMU) 314 and a decision feedback unit (DFU) 315. Among the blocks shown in FIG. 6, the 1D-BMU 311, the 4D-BMU 312, the ACSU 313 and the SMU 314 collectively form the TCM decoder, which then joints the DFU 315. Specifically, the 1D-BMU 311 calculates 1D branch metrics λₙ^{A,B,C,D}, and the 4D-BMU 312 combines the 1D branch metrics (1D-BMs) from the 1D-BMU 311 to generate 4D branch metrics (4D-BMs). Subsequently, the ACSU 313 performs ACS operation on the 4D-BMs, for each code state, to obtain path metrics, According to one aspect of the present invention, the SMU 314 of the present embodiment stores to keep track of symbols, rather than storing surviving state transition to record path history as in conventional counterpart. The DFU 315 of the present embodiment is coupled to receive the 1D symbols directly from the SMU 314 in order to estimate ISI quantity uₙ^{A,B,C,D}, which is then fed back to the 1D-BMU 311 to assist in 1D-BMs calculation. The details of the blocks of FIG. 6 are descried in the following paragraphs.

In the embodiment, the 1D branch metrics (1D-BMs) λₙ^{A,B,C,D} corresponding to code state ρₙ and wire pair (or channel) j (j=A, B, C or D) at time n may be calculated in the 1D-BMU 311 according to

λₙ^{j}(zₙ^{j},aₙ^{j},ρₙ)=(zₙ^{j}−aₙ^{j}+uₙ^{j}(ρₙ))².

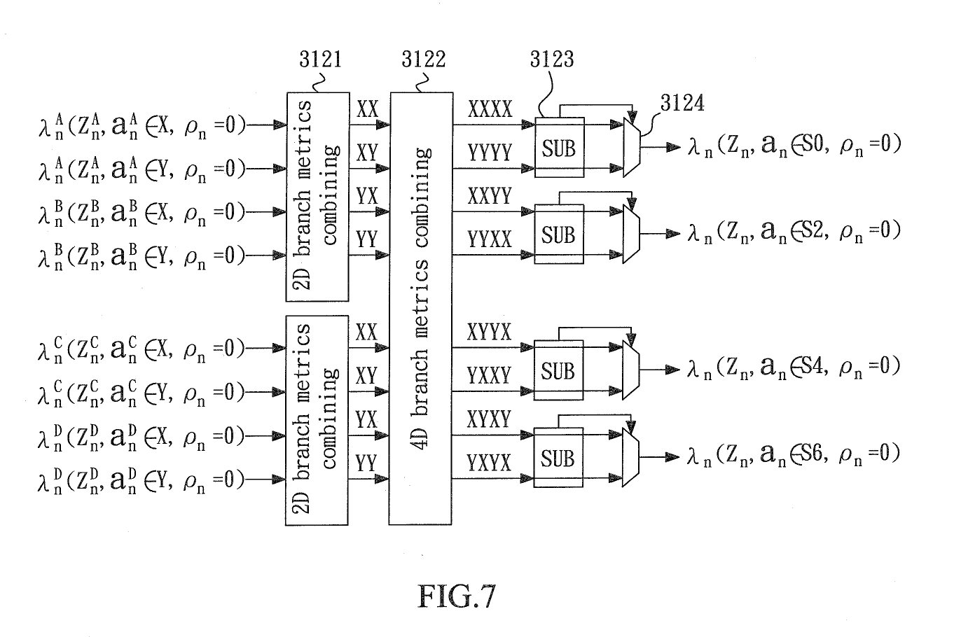

FIG. 7 shows a detailed block diagram exemplifying the 4D-BMU 312 for calculating 4D branch metrics (4D-BMs) from state 0. The 1D branch metrics (1D-BMs) λₙ^{A,B,C,D} are first combined by 2D-BM combining block 3121 to form 2D branch metrics, followed by being combined to form 4D branch metrics by a 4D-BM combining block 3122. The complementary 4D branch metrics (e.g., XXYY and YYXX) are then compared by a comparator 3123, which may be preferably implemented by a subtracting device (SUB). The 4D branch metric with least value will be selected by a selecting device 3124, which may be preferably implemented by a multiplexer.

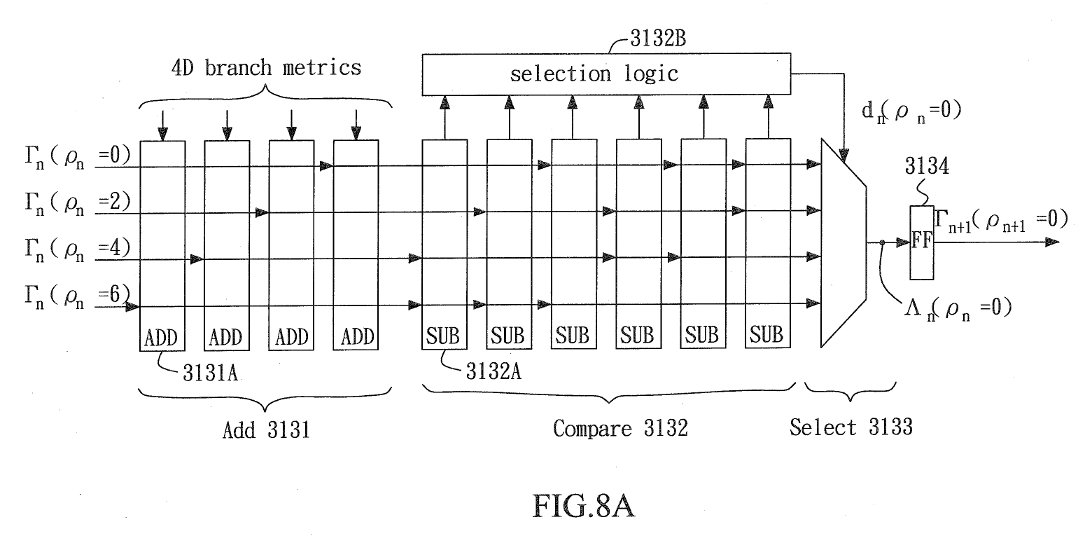

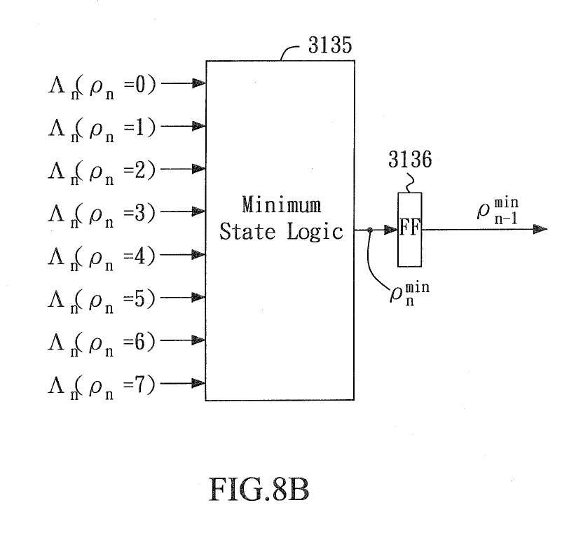

FIG. 8A shows a detailed block diagram exemplifying the ACSU 313 for updating the path metrics for state 0. The ACSU 313 generally includes an add portion 3131, a compare portion 3132 and a select portion 3133. Specifically, the add portion 3131 adds the 4D branch metrics to the current path metrics ┌ₙ by adders (ADDs) 3131A respectively. Subsequently, the outputs of the add portion 3131 are compared, e.g., two by two, by comparators 3132A such as subtracting devices (SUBs). The comparison results are processed by a selection logic 3132B to result in a decision value dₙ, which selects the output Λₙ of the add portion 3131 with least value. An updated path metric ┌ₙ₊₁ may then be obtained from a flip-flop (FF) 3134 that is coupled to receive the output Λₙ of the add portion 3131 with least value.

As shown in FIG. 8B, the ACSU 313 of the present embodiment may further include a minimum state logic 3135 that outputs the state ρₙ with least value of the output Λₙ of the select portion. 3133, thereby resulting in a minimum state ρₙ^{min} at time n. A minimum state ρₙ₋₁^{min} at time n−1 may be obtained from a flip-flop (FF) 3136 that is coupled to receive the minimum state ρₙ^{min} at time n.

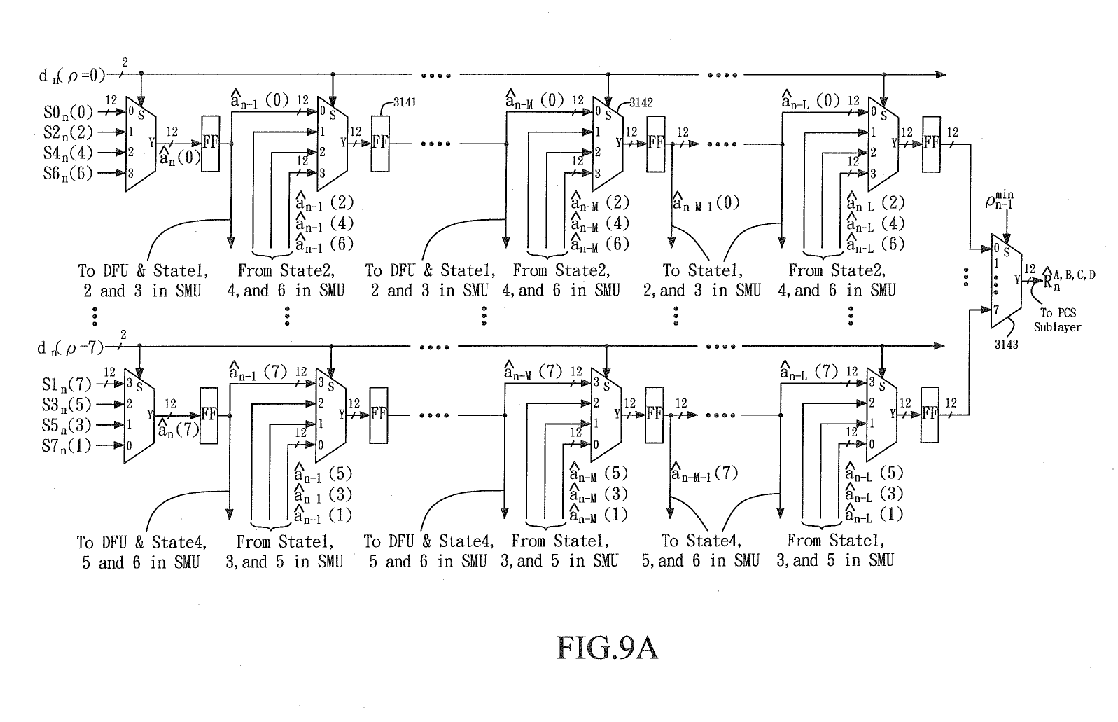

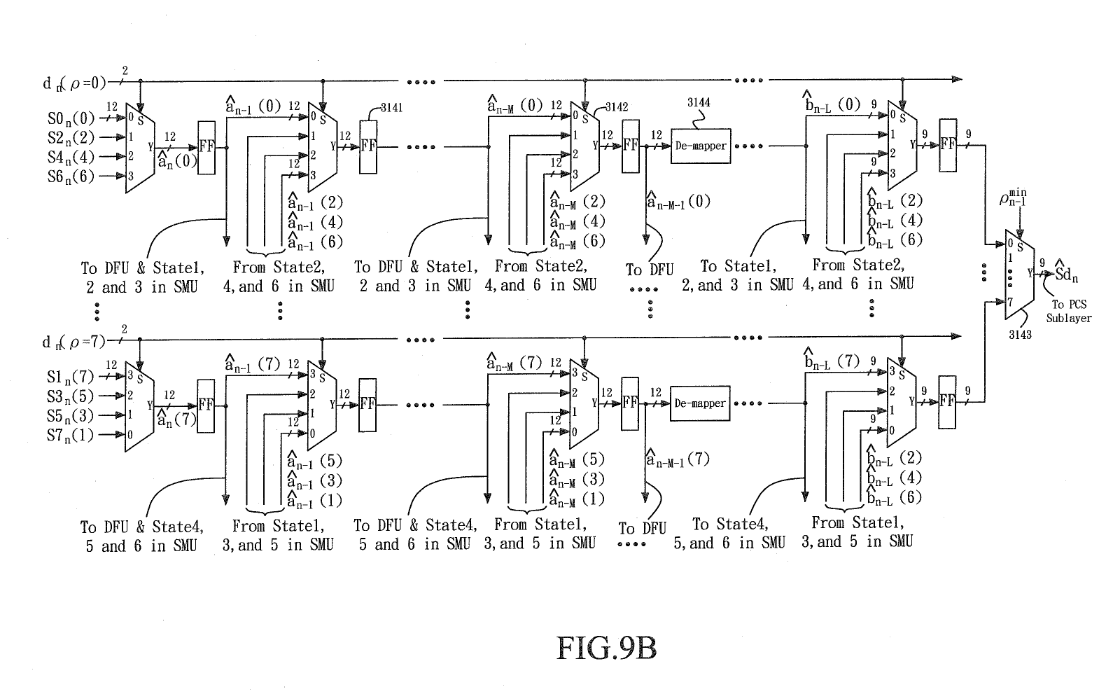

FIG. 9A shows a detailed block diagram of the SMU 314 (FIG. 6) according to one embodiment of the present invention. In the embodiment, the SMU 314 includes a number of chains, each of which corresponds to a distinct state ρ. In the embodiment, each chain includes a series of L flip-flops (FFs) 3141 that are used to store symbols â in a chronological order. Selecting devices 3142 such as multiplexers are respectively interspersed between the adjacent FFs 3141 to select the symbol a according to the decision value dₙ of the selection logic 3132B in the ACSU 313 (FIG. 8A). As a result, a history or chronicle of preceding symbols may be stored in the SMU 314. According to one aspect of the present invention, the present embodiment further includes a selecting device 3143 such as a multiplexer that selects the output symbol from the chain that corresponds to the minimum state ρₙ₋₁^{min} at time n−1 (FIG. 8B). Accordingly, the reliability of the entire transceiver may be further increased. The 12-bit output \hat{R}ₙ^{A,B,C,D} of the selecting device 3143 is de-mapped to 9-bit data before being fed to the PCS block 21 (FIG. 2).

FIG. 9B shows a detailed block diagram of the SMU 314 (FIG. 6) according to another embodiment of the present invention. The present embodiment is similar to FIG. 9A in structure, except that a de-mapper 3144 is used in each chain corresponding to a distinct state ρ in order to de-map the 1.2-bit symbols â to a 9-bit data. Accordingly, the 9-bit output \hat{R}ₙ^{A,B,C,D} of the selecting device 3143 may be directly fed to the PCS block 21 (FIG. 2).

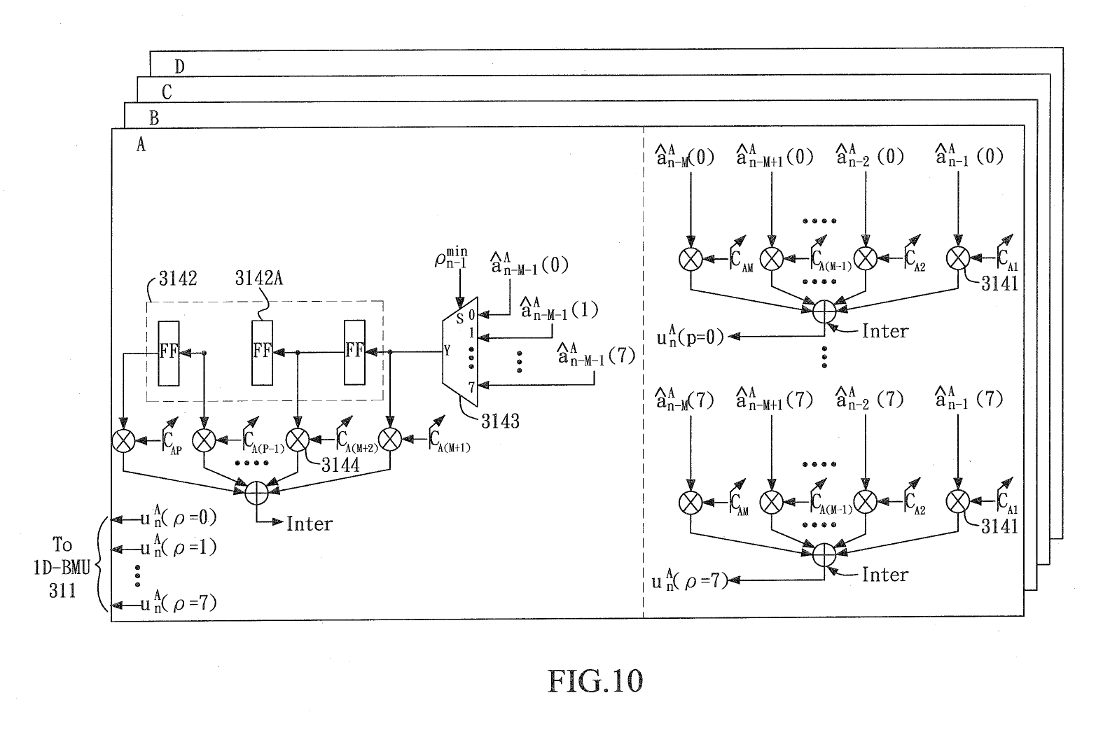

FIG. 10 shows a detailed block diagram of the DFU 35 (FIG. 6) according to one embodiment of the present invention. Specifically, for each dimension A, B, C or D, the DFU 35 includes eight first filters for eight. Trellis states ρ (=0 to 7) respectively, as shown on the right-hand side of the figure. Each first filter is coupled to receive symbols â^{A,B,C,D} from the SMU 314 (FIG. 6). The symbols â^{A,B,C,D} are then multiplied by coefficients C_{A1}, C_{A2} to C_{AM}, e.g., by multipliers 3141 respectively. The multiplied symbols are then summed up with an intermediate value (Inter) that is generated from a second filter as shown on the left-hand side of the same figure. The output, i.e., the estimated. ISI quantity uₙ^{A,B,C,D}, of the first filters is then fed back to the 1D-BMU 311 (FIG. 6). The second filter, for each dimension A, B, C or D, includes a shift register 3142 made of a series of flip-flops (FFs) 3142A that is coupled to receive a symbol â^{A,B,C,D} from the SMU 314, e.g., by a multiplexer 3143 according to the minimum, state ρₙ₋₁^{min} at time n−1. The symbols outputted from the shift register 3142 are multiplied by coefficients C_{A(M+1)}, C_{A(M+2)} to C_{AP}, e.g., by multipliers 3144 respectively. The multiplied symbols are then summed up to generate the intermediate value (Inter). Compared to the conventional SMU such as that disclosed in Lin et al., the SMU 314 of the present embodiment eliminates the need of shifter registers in the first filters. Moreover, the decision device in Lin. et al. may also be eliminated, thereby simplifying the overall structure of the SMU.

Although specific embodiments have been illustrated and described, it will be appreciated by those skilled in the art that various modifications may be made without departing from the scope of the present invention, which is intended to be limited solely by the appended claims.

What is claimed is:

1. A joint decision feedback equalizer (DFE) and Trellis decoder adaptable to an Ethernet transceiver, comprising:
a Trellis coded modulation (TCM) decoder including:
a one-dimensional branch metric unit (1D-BMU) configured to calculate 1D branch metrics;
a four-dimensional branch metric unit (4D-BMU) configured to combine the 1D branch metrics to generate 4D branch metrics;
an add-compare-select unit (ACSU) configured to perform add, compare and select (ACS) operations on the 4D branch metrics for each state to obtain path metrics;
a survivor memory unit (SMU) configured to store and keep track of symbols; and
a decision feedback unit (DFU) coupled to receive the symbols from the SMU in order to estimate inter-symbol interference (ISI) quantity, which is then fed back to the 1D-BMU.

2. The joint DFE and the Trellis decoder of claim 1, wherein the Ethernet transceiver is compliant with 1000BASE-T.

3. The joint DFE and the Trellis decoder of claim 1, wherein the 4D-BMU comprises:
a plurality of 2D-BM combining blocks configured to form 2D branch metrics according to the 1D branch metrics;
a 4D-BM combining block configured to combine the 2D branch metrics to form the 4D branch metrics;
a plurality of comparators, each of which is configured to compare the 41D branch metrics that are complementary to each other; and
a selecting device configured to select the 4D branch metric that has least value.

4. The joint DFE and the Trellis decoder of claim 3, wherein the comparator comprises a subtracting device.

5. The joint DFE and the Trellis decoder of claim 3, wherein the selecting device comprises a multiplexer.

6. The joint DFE and the Trellis decoder of claim 1, wherein the ACSU comprises:
an add portion configured to add the 4D branch metrics to current path metrics;
a compare portion configured to compare outputs of the add portion, thereby resulting in a decision value; and
a select portion configured to select the least-value output of the add portion according to the decision value.

7. The joint DFE and the Trellis decoder of claim 6, further comprising a flip-flop coupled to receive the least-value output of the add portion, thereby resulting in an updated path metric.

8. The joint DFE and the Trellis decoder of claim 6, further comprising a minimum state logic configured to output a minimum state corresponding to the least-value output of the select portion.

9. The joint DFE and the Trellis decoder of claim 8, wherein the SMU comprises a plurality of chains, each of which corresponds to a distinct state.

10. The joint DFE and the Trellis decoder of claim 9, wherein each said chain comprises:
a series of flip-flops (FFs) configured to store the symbols in a chronological order;
a plurality of multiplexers respectively interspersed between the adjacent FFs for selecting the symbol according to the decision value of the compare portion; and
a selecting device configured to select the symbol outputted from the chain corresponding to the minimum state.

11. The joint DFE and the Trellis decoder of claim 10, further comprising a de-mapper disposed in the chain for de-mapping the symbols.

12. The joint DFE and the Trellis decoder of claim 1, wherein the DFU comprises:
a plurality of first filters corresponding to the states respectively, wherein each said first filter is coupled to receive the symbols from the SMU;
a plurality of first multipliers, in each said first filter, configured to multiply the symbols by first coefficients respectively, wherein the multiplied symbols from the first multipliers are then summed up with an intermediate value; and
a second filter configured to generate the intermediate value according to the symbol received from the SMU.

13. The joint DFE and the Trellis decoder of claim 12, wherein the second filter comprises:
a shift register coupled to receive the symbol from the SMU; and
a plurality of second multipliers configured to multiply the symbols outputted from the shift register by second coefficients respectively, wherein the multiplied symbols from the second multipliers are then summed up to generate the intermediate value.
